(19) United States
(12) Patent Application Publication
(10) Pub. No.: US 2026/0170244 A1
(43) Pub. Date: Jun. 18, 2026

(54) LOOK AHEAD WINDOW SIZE FOR SPECULATIVE DECODING

(71) Applicants: XILINX, INC., SAN JOSE, CA (US); ADVANCED MICRO DEVICES, INC., Santa Clara, CA (US)

(72) Inventors: Ephrem Wu, San Mateo, CA (US); Yao Cui Fehlis, New Braunfels, TX (US); Jalal Uddin Mahmud, San Jose, CA (US)

(21) Appl. No.: 18/983,599

(22) Filed: Dec. 17, 2024

(51) Int. Cl. G06F 40/284; G06F 40/40

(52) U.S. Cl. CPC G06F 40/284; G06F 40/40

(57) ABSTRACT

A method includes, for speculative decoding using a draft model that generates look ahead tokens for a target model, splitting an input dataset into a first set and a second set. The method also includes, using the first set, computing an expected number of look ahead tokens accepted by the target model per call based on a first value indicative of a quantity of look ahead tokens generated by the draft model per call to the target model, and modifying the quantity of look ahead tokens generated by the draft model to a second value based on the expected number of look ahead tokens accepted by the target model. Then, the method includes, with the second set, performing speculative decoding with a look ahead window size based on the second value.

### BACKGROUND

Large language model (LLM) inferencing involves utilizing a pre-trained model to generate output text (e.g., responses to questions, text to complete a sentence, a summarization of text, etc.) based on input text (e.g., a question, an initial segment of a sentence, text to be summarized, etc.). The process of LLM inferencing includes generating tokens (small units of text) based on the input text and the LLM's vocabulary, passing the tokens through multiple layers of one or more neural networks for processing to generate output tokens, and decoding the output tokens into coherent output text. In some cases, the efficiency of LLM inferencing can be improved by optimizing speed and resource management to better handle real-time applications. For example, LLM inferencing can be accelerated by algorithmic techniques such as speculative decoding. Speculative decoding seeks to reduce compute, memory, and power consumption without any loss in quality of the output of the LLM.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a processing system including an accelerated processing unit (APU) to tune parameters for speculative decoding at one or more compute units of a processing pipeline in accordance with some embodiments.

FIG. 2 shows an example diagram of a portion of the processing system of FIG. 1 including components within the APU in accordance with some embodiments.

FIG. 3 shows an example of a speculative decoding configuration implemented by the APU of FIGS. 1 and 2 in accordance with some embodiments.

FIG. 4 shows an example of a flowchart illustrating a method for an APU, such as the APU of FIGS. 1 and 2, to perform speculative decoding with a dynamic look ahead window size determination in accordance with some embodiments.

FIG. 5 shows an example histogram illustrating a distribution of accepted draft model tokens per call to a target model in a speculative decoding configuration in accordance with some embodiments.

FIG. 6 shows an example of a graph plotting the speculative decoding speed-up, e.g., indicated by an expected parameters read reduction (EPRR), versus a look ahead window size (K) to determine the look ahead window size to use in speculative decoding in accordance with some embodiments.

### DETAILED DESCRIPTION

Conventional LLM inferencing generates text from a single language model by utilizing autoregressive sampling which includes generating X tokens (where X is a positive integer) in X serial runs of the model. That is, conventional LLM inferencing employs one language model that generates one token per pass. For example, based on an input prompt of “The dog”, the conventional LLM inferencing model generates a first token “is” in a first pass to output “The dog is”, a second token “sleeping” in a second pass to output “The dog is sleeping”, a third token “on” in a third pass to output “The dog is sleeping on”, and so on until the final output of “The dog is sleeping on the floor” is generated. Using LLM to perform autoregressive sampling in this manner is slow since generating a single token requires a complete run throughout the LLM, which in some cases may include billions (e.g., 10 billion (B), 100 B, or more) of parameters.

Speculative decoding, on the other hand, runs two LLMs in parallel to speed up LLM inferencing: a large, comprehensive LLM to be employed to generate the final output text (referred to herein as the “target model”) and a second, smaller LLM (referred to herein as the “draft model”) that runs in parallel with the target model. The smaller draft model, in some cases, is an order (or more) of magnitude smaller than the target model and generates multiple look ahead (or “speculative”) tokens over multiple passes quicker than the target model is able to generate one token. Thus, the draft model is employed to “predict” a plurality of look ahead tokens and send the plurality of look ahead tokens to the target model. The target model then checks the plurality of look ahead tokens from the draft model while producing an additional token itself in a single pass through the target model. Thus, speculative decoding leverages the way transformer LLMs work since, even though LLMs can generate one token at a time (i.e., in a single pass), LLMs can check multiple tokens at once (i.e., in parallel) while generating a token in the same pass.

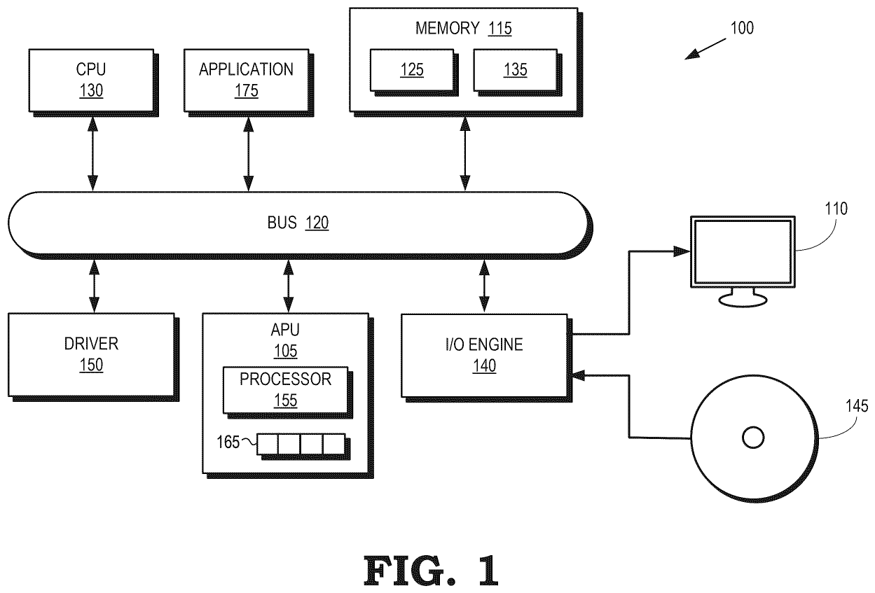

Speculative decoding thus employs the faster, but smaller, draft model in parallel with the more comprehensive, but slower, target model to speed up LLM inferencing without sacrificing accuracy. For example, the draft model can quickly generate five look ahead tokens in response to an initial prompt (e.g., a question) which are then checked by the target model while the target model also generates a token in the same single pass. If one or more of the look ahead tokens from the draft model are accepted by the target model, then at least one additional token is generated by speculative decoding per pass on the target model compared to if speculative decoding is not used (i.e., if the draft model is not used and only the target model is used). In this manner, speculative decoding can speed up LLM inferencing by 2× or more without degrading the quality of the LLM output. However, the acceleration benefits of speculative decoding are dependent on several speculative decoding parameters such as selecting the number of look ahead tokens (also referred to as a “look ahead window size”). In some cases, using a particular look ahead window size can slow down the LLM inferencing process if the look ahead window size is too large. Conventional techniques typically rely on human intervention to implement a trial-and-error based approach to find the optimal look ahead window size to use in speculative decoding. The techniques described in FIGS. 1-6 provide an automated statistical approach to compute a look ahead window size for speculative decoding, thereby improving the efficiency and the speed of LLM inferencing.

To illustrate, in some embodiments, a method includes a processor employing a speculative decoding configuration including a draft model that generates look ahead tokens for a target model. The processor splits an input dataset to the speculative configuration into a first set and a second set. In some embodiments, the first set is a first subset (i.e., portion) of the input dataset, and the second set is a larger, second subset of the input dataset. In some embodiments, the first set and the second set do not overlap (i.e., they are distinct subsets from one another). The processor employs the first set to perform an initial calibration procedure. This initial calibration procedure includes computing an expected number of look ahead tokens accepted by the target model per call (i.e., per pass) based on a first value indicative of a quantity of look ahead tokens generated by the draft model per call to the target model. The initial calibration procedure further includes modifying the quantity of look ahead tokens generated by the draft model to a second value based on the expected number of look ahead tokens accepted by the target model. Then, the processor employs the second set to perform speculative decoding with a look ahead window size based on the second value. In this manner, the processor employs a tailored statistical approach using the first set to determine a look ahead window size which it then employs during speculative decoding using the second set. Tailoring the look ahead window size in this manner improves the efficiency and speed of speculative decoding, thereby improving the performance of the LLM.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., the components in the APU or other components associated with the techniques described herein) represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuit.

FIG. 1 shows an example of a processing system 100 that includes an accelerated processing unit (APU) 105 with a processor 155 to determine a look ahead window size to employ in speculative decoding at a processing pipeline 165 in accordance with some embodiments. For example, in some cases, the processing pipeline 165 of the APU 105 includes a plurality of compute units (CUs) or processor cores that are configured to execute instructions of a wavefront concurrently or in parallel. In some cases, the wavefronts are associated with compute operations such as machine learning operations or executing an LLM. In other cases, the wavefronts are associated with graphics operations to render images intended for output to a display 110. The processing system 100 also includes a memory 115. Some embodiments of the memory 115 are implemented as a dynamic random access memory (DRAM). In other embodiments, the memory 115 is alternatively or additionally implemented using other types of memory including static random access memory (SRAM), nonvolatile RAM, and the like. In the illustrated embodiment, the APU 105 communicates with the memory 115 over a bus 120. However, some embodiments of the APU 105 communicate with the memory 115 over a direct connection or via other buses, bridges, switches, routers, and the like. The APU 105 executes instructions stored in the memory 115 and the APU 105 stores information in the memory 115 such as the results of the executed instructions. For example, the memory 115 can store a copy 125 of instructions from a program code that is to be executed by the APU 105 or store a plurality of datasets that are retrieved by the APU 105 to execute an LLM.

The processing system 100 is generally configured to execute sets of instructions (e.g., computer programs) such as an application 175 to conduct specified tasks for an electronic device. Examples of such tasks include controlling aspects of the operation of the electronic device, performing computations associated with machine learning or databasing applications, displaying information to a user to provide a specified user experience, communicating with other electronic devices, and the like. Accordingly, in different embodiments the processing system 100 is employed in one of a number of types of electronic device, such as a desktop computer, laptop computer, server, game console, tablet, smartphone, and the like. In some cases, the processing system 100 may include more or fewer components than illustrated in FIG. 1. For example, the processing system 100 may additionally include one or more input interfaces, non-volatile storage, one or more output interfaces, network interfaces, and one or more displays or display interfaces.

The processing system 100 includes a central processing unit (CPU) 130 for executing instructions. Some embodiments of the CPU 130 include multiple processor cores (not shown in the interest of clarity) that independently execute instructions concurrently or in parallel. The CPU 130 is also connected to the bus 120 and therefore communicates with the APU 105 and the memory 115 via the bus 120. The CPU 130 executes instructions such as program code 135 stored in the memory 115 and the CPU 130 stores information in the memory 115 such as the results of the executed instructions. The CPU 130 is also able to initiate graphics processing by issuing draw calls to the APU 105 or initiate machine learning operations by issued corresponding commands to the APU 105. A draw call is a command that is generated by the CPU 130 and transmitted to the APU 105 to instruct the APU 105 to render an object in a frame (or a portion of an object). Some embodiments of a draw call include information defining textures, states, shaders, rendering objects, buffers, and the like that are used by the APU 105 to render the object or portion thereof. The APU 105 renders the object to produce values of pixels that are provided to the display 110, which uses the pixel values to display an image that represents the rendered object.

An input/output (I/O) engine 140 handles input or output operations associated with the display 110, as well as other elements of the processing system 100 such as keyboards, mice, printers, external disks, and the like. The I/O engine 140 is coupled to the bus 120 so that the I/O engine 140 communicates with the APU 105, the memory 115, or the CPU 130. In the illustrated embodiment, the I/O engine 140 is configured to read information stored on an external storage medium 145. The external storage medium 145 stores information representative of program code used to implement an application such as a video game. The program code on the external storage medium 145 can be written to the memory 115 to form the copy 125 of instructions that are to be executed by the APU 105 or the CPU 130.

The driver 150 is a computer program that enables a higher-level computing program, such as from the application 175, to interact with the APU 105. For example, the driver 150 translates standard code received from the application 175 into a native format command stream understood by the APU 105. The driver 150 allows input from the application 175 to direct settings of the APU 105. Such settings include selection of a render mode, an anti-aliasing control, a texture filter control, a batch binning control, and deferred pixel shading control, for example. In some embodiments, the performance of the APU 105 is enhanced by the driver 150 choosing the appropriate mode or setting for the APU 105 to operate based on the instructions issued by the application 175 running on the CPU 130. In some cases, the driver 150 is updated via a software or firmware update to improve the performance, stability, and compatibility of the APU 105 with the various other components of the processing system 100.

In some embodiments, the APU 105 has a processing pipeline 165 that includes highly parallel processing capabilities to execute the workloads issued to it by the CPU 130 or the driver 150. For example, in the case of executing graphics operations, the processing pipeline 165 is a graphics pipeline that includes multiple stages configured for concurrent processing of different primitives in response to a draw call. Stages of the graphics pipeline in the APU 105 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene. The shaders that are implemented in the graphics pipeline state are represented by corresponding byte codes. In some cases, the information representing the graphics pipeline state is hashed or compressed to provide a more efficient representation of the graphics pipeline state. In other cases, the processing pipeline 165 is a compute processing pipeline configured to execute machine learning or neural network type operations. For example, the processing pipeline 165 is configured to implement a neural network (NN) that receives input data at an input layer of the NN, performs operations on the input data to generate processed data at one or more processing layers of the NN, and generates an output based on the processed data via an output layer of the NN.

In some embodiments, the APU 105 is configured to execute LLM inferencing to generate text based on an initial prompt. The processor 155 of the APU 105 receives an LLM prompt (or prompt for brevity) from the CPU 130 or the application 175 and generates an output based on the prompt. For example, the prompt may include a question, an initial segment of text to be completed, a block of text to be summarized, or the like. The processor 155 passes the generated plurality of tokens to the processing pipeline 165, which processes the tokens through multiple layers of one or more neural networks to generate output tokens. The processing pipeline 165 then decodes the output tokens into output text.

In some cases, the APU 105 is configured to accelerate LLM inferencing by executing an algorithmic technique. One example of such an algorithmic technique is speculative decoding. To execute speculative decoding, the processing pipeline 165 employs a draft model in parallel with a target model. The draft model employs an autoregressive model to generate a sequence of look ahead tokens (also herein referred to as a “prefix token sequence”) in response to receiving the prompt and feeds the prefix token sequence to the target model. The target model checks the validity of the prefix token sequence from the draft model. For instance, the target model checks each look ahead token of the prefix token sequence in order (i.e., starting with the first look ahead token in the prefix token sequence). If the target model confirms the validity of the look ahead token, the target model accepts the look ahead token as part of a valid prefix token sequence and moves on to check the next look ahead token in the prefix token sequence. If the target model rejects the next look ahead token in the prefix token sequence, the target model stops checking the rest of the prefix token sequence. For example, if the target model accepts the first two look ahead tokens but rejects the third look ahead token in the prefix token sequence, the target model stops checking and discards the look ahead tokens starting with the third look ahead token in the prefix token sequence and accepts the first two look ahead tokens as the valid prefix token sequence. A valid prefix token sequence implies that the draft model “appears” to draw tokens out of a distribution that is identical to that of the target model. This illusion allows the target model to append its own generated token to the accepted look ahead tokens (of the valid prefix token sequence) from the draft model without having to read additional LLM parameters. Thus, the target model generates an additional token and appends the additional token to the last accepted look ahead token (if any) from the draft model. In some cases, the target model checks the validity of the look ahead tokens from the draft model (i.e., the target model determines whether to accept one or more of the look ahead tokens based on the look ahead tokens satisfying a predetermined criteria) and generates the additional token in a single pass. In some embodiments, the draft model is one or more orders of magnitude smaller than the target model. For example, in some embodiments, the target model is about two or three orders of magnitude larger than the draft model. If the target model rejects all the look ahead tokens from the draft model (e.g., if the look ahead tokens do not satisfy one or more predetermined criteria of a rejection sampling model), then the target model appends the additional token it generates to the tokens generated from the prompt or from the last round of speculative decoding. That is, even if the target model rejects all of the look ahead tokens from the draft model, the target model still generates a token from the single pass that it otherwise would have generated even if draft model would not have been used.

To accelerate speculative decoding according to the techniques described herein, in some embodiments, the APU 105 employs a statistical approach to select an optimal look ahead window size (i.e., an optimum number of look ahead tokens generated by the draft model and passed to the target model for checking) for a speculative decoding configuration implemented at the processing pipeline 165. For example, the APU 105 retrieves a dataset from the memory 115. The APU 105 splits the dataset into a first set and a second set. In some embodiments, the first set is a first subset (or portion) of the input dataset, and the second set is a larger, second subset of the input dataset. Using the first set, the APU 105 (e.g., via the processing pipeline 165 or another component of the APU 105) computes an expected number of look ahead tokens accepted by the target model per call based on a first value indicative of a quantity of look ahead tokens generated by the draft model per call to the target model. For example, in some cases, the APU 105 selects the first value based on a historical data distribution of accepted tokens per call to the target model. Then, the APU 105 modifies the quantity of look ahead tokens generated by the draft model to a second value based on the expected number of look ahead token accepted by the target model. Afterwards, the APU 105 performs speculative decoding (e.g., via the processing pipeline 165) using the second set, wherein the speculative decoding employs a look ahead window size based on the second value. By using a statistical approach based on the first set to determine the look ahead window size, the APU 105 improves the speculative decoding speed, thereby reducing the LLM inferencing time.

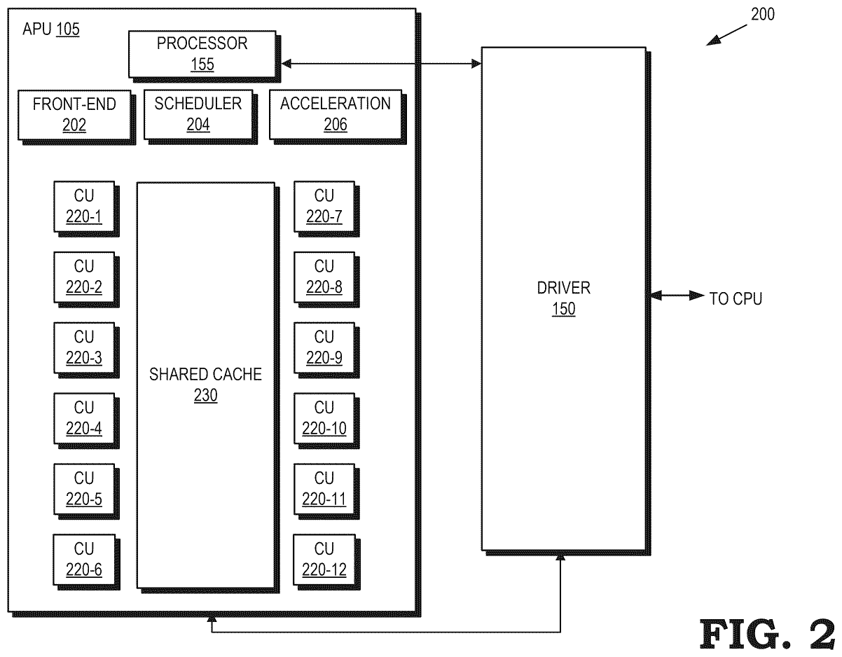

FIG. 2 shows an example diagram of a portion 200 of the processing system 100 of FIG. 1 in accordance with some embodiments. In the illustrated embodiment, the portion 200 of the processing system includes the driver 150 and the APU 105 that is configured to execute workloads for one or more applications, such as the application 175 of FIG. 1, running on a processing system, such as the processing system 100 of FIG. 1. In some embodiments, the applications include one or more of a compute application, a graphics application, or a combination thereof that issues respective sets of instructions (or threads) to a CPU, such as CPU 130 of FIG. 1, which then communicates the instructions to the APU 105 via the driver 150.

In the illustrated embodiment, the APU 105 includes the aforementioned processor 155 that is configured to receive a command stream (e.g., a prompt to an LLM implemented at one or more components of the APU 105), from a CPU such as CPU 130 via the driver 150, indicating one or more workgroups to be executed at the APU 105. After receiving the command stream, the processor 155 parses the command stream and issues respective instructions of the indicated workgroups to a front-end circuitry 202, a scheduling circuitry 204, or both. Based on the instructions of the workgroups received from the processor 155, the front-end circuitry 202, the scheduler circuitry 204, or both are configured to provide data indicating threads (e.g., operations) to be executed for the workgroups to a processing pipeline.

The APU 105 also includes a plurality of compute units (CUs) 220 configured to implement a processing pipeline, such as the processing pipeline 165 of FIG. 1. The scheduler circuitry 204, in one example, is configured to update one or more registers of one or more of the CUs 220 that is configured to execute a first group of wavefronts, where a wavefront is a group of threads executed simultaneously. In some cases, the term “wavefront” is interchangeably referred to as a warp, vector, or thread. In some cases, wavefronts are grouped into workgroups. After the corresponding compute unit 220 has executed the first group of wavefronts, scheduler circuitry 204 updates one or more registers of the compute unit 220 to schedule a second group of wavefronts of the workgroup to be executed by the compute unit 220. To execute these wavefronts, each compute unit is connected to a shared cache 230 that includes a volatile memory, non-volatile memory, or a combination thereof accessible by one or more compute units 220. The shared cache 230, for example, is configured to store data (e.g., register files, values, operands, instructions, variables) used in the execution of one or more wavefronts, data resulting from the performance of one or more wavefronts, or both. Because the shared cache 230 is accessible by multiple ones of the compute units 220, a first compute unit, e.g., compute unit 220-1, is enabled to provide results from the execution of a first wavefront to a second compute unit, e.g., compute unit 220-2, executing a second wavefront. Though the example embodiment presented in FIG. 2 shows the APU 105 as including 12 CUs (220-1 to 220-12), in other implementations, the APU 105 can include another number of compute units 220, e.g., 16, 32, or another number of compute units.

Additionally, in the illustrated embodiment, to help perform instructions for one or more workgroups, the APU 105 includes the acceleration circuitry 206. Such acceleration circuitry 206 includes hardware (e.g., fixed-function hardware) configured to execute one or more instructions for one or more workgroups. As an example, the acceleration circuitry 206 includes one or more instances of fixed function hardware configured to encode frames, encode audio, decode frames, decode audio, display frames, output audio, perform matrix multiplication, or any combination thereof. To schedule instructions for execution on such hardware, the scheduler circuitry 204 is configured to update one or more physical registers (not shown for clarity purposes) of the acceleration circuitry 206.

In some embodiments, the APU 105 is configured to execute speculative decoding techniques to accelerate LLM inferencing. That is, the APU 105, via a combination of the processor 155, the front-end circuitry 202, the scheduler 204, the acceleration circuitry 206, and one or more of the compute units 220, performs the techniques described herein to select a look ahead window size to achieve faster rates of speculative decoding, thereby increasing the speed of the LLM inferencing model implemented by the APU 105. For example, the APU 105 is configured to employ a statistical approach as described herein to determine the look ahead window size to use in speculative decoding via the acceleration circuitry 206, one or more of the compute units 220, or a combination thereof.

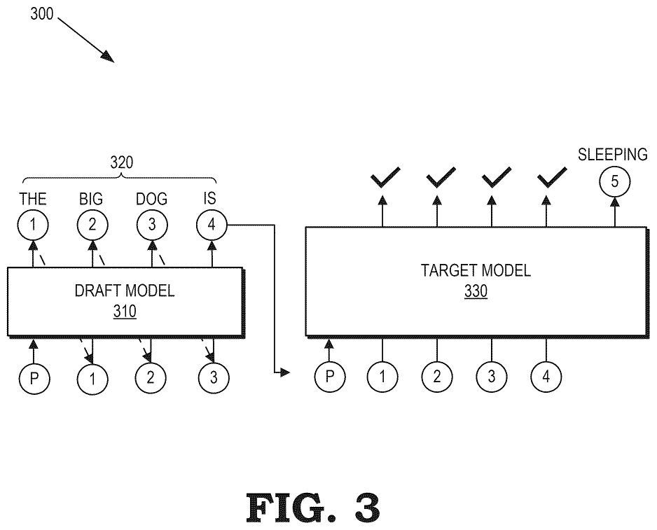

FIG. 3 shows an example of a speculative decoding configuration 300, which is implemented by the APU 105 of FIGS. 1 and 2, in accordance with some embodiments. The speculative decoding configuration 300 runs a target model 330 and a draft model 310 in parallel to improve LLM inferencing speeds without reducing accuracy. In some embodiments, the techniques described herein employ a statistical approach to determine the look ahead window size (or the number of look ahead tokens generated by the draft model at each iteration) per pass to the draft model to accelerate the LLM inferencing time.

The speculative decoding configuration 300 shows an iteration of speculative decoding according to some aspects which utilizes the target model 330 and the draft model 310 to accelerate LLM inferencing. The smaller draft model 310 predicts a number K (where K is a positive integer) of look ahead tokens over multiple passes through the draft model 310. In the illustrated embodiment, K is equal to 4. The number of look ahead tokens (K) generated by the draft model 310 and passed to the target model 330 in a single pass (or call) is also referred to herein as a “look ahead token length” or a “look ahead window size” and is denoted by the window size 320. The target model 330 checks each one of the look ahead tokens generated by the draft model 310 in order while generating a token of its own in a single pass. For example, in some embodiments, the draft model 310 generates a prediction probability (e.g., a value between 0 and 1) for each of its look ahead tokens, and the target model 330 compares the prediction probabilities from the draft model 310 with its own prediction probabilities while generating an addition token in the single pass. In some cases, if the prediction probabilities from the draft model 310 and the target model 330 satisfy one or more criteria (e.g., the prediction probability of the target model 330 is higher than that of the draft model 310), the target model 330 accepts the look ahead tokens. In this manner, the speculative decoding configuration 300 leverages the autoregressive nature of the draft model 310 to do sequential predictions based on the smaller size (e.g., fewer parameters) of the draft model 310 and then utilizes the larger, more comprehensive target model 330 to verify the predictions of draft model 310 while generating a token of its own in a single pass.

Referring to the embodiment illustrated in FIG. 3, the speculative decoding configuration 300 receives one or more initial tokens, P, based on a prompt. For example, the prompt is the question “What is the big dog doing?”, and the speculative decoding configuration 300 generates one or more initial tokens, P, based on the prompt. Conventional LLMs employ a single, large LLM model to generate one token per pass, which is time consuming. The speculative decoding configuration 300 utilizes a smaller draft model 310 that is, in some cases, orders of magnitude smaller than the target model 330. For example, in some implementations, the draft model 310 is an LLM based on 1B parameters and the target model 330 is an LLM based on 100B parameters. The smaller draft model 310 generates one look ahead token per sequential pass (or iteration) through its smaller number of parameters and appends the look ahead token to the look ahead token from the previous pass (if any) up to K look ahead tokens.

In the illustrated example, the draft model 310 sequentially generates 4 look ahead tokens in 4 passes. That is, in the illustrated example, the look ahead window size 320 is 4 (i.e., K=4). In particular, in a first pass (or iteration) through its LLM, the draft model 310 generates a first token (“The”), then a second token (“big”) in a second pass, then a third token (“dog”) in a third pass, and then a fourth token (“is”) in a fourth pass. In some embodiments, the draft model 310 generates a draft model probability distribution for each of the look ahead tokens. For example, during reach autoregressive pass through the draft model 310, the draft model 310 generates a probability distribution over the draft model's 310 vocabulary, and then the draft model 310 samples this probability distribution to generate the look ahead token for the respective pass. The four look ahead tokens (“The big dog is”) are then input to the target model 330 along with the one or more initial tokens from the prompt, P. The target model 330 checks the four look ahead tokens from the draft model 310 by comparing their respective draft model probability distribution with a target model probability distribution generated by the target model 330 over its own vocabulary (which is larger than that of the draft model 310 due to having a greater number of parameters), and then generates a fifth token (“sleeping”) in a single pass through its larger LLM. Thus, the target model 330 leverages the parallel nature of LLMs to check the sequence of look ahead tokens generated by the draft model 310 and to generate an additional token (the fifth token in this example).

Although not illustrated, in some cases, the target model 330 accepts fewer or none of the look ahead tokens generated by the draft model 310. In some embodiments, the target model 330 accepts or rejects the look ahead tokens generated by the draft model 310 based on a rejection sampling model. For example, the rejection sampling model includes determining whether to accept or reject the first look ahead token of the look ahead token sequence by comparing the target model probability distribution for the first look ahead token generated by the target model 330 to the draft model probability distribution for the first look ahead token generated by the draft model 310. If the target model probability distribution is greater than the draft model probability distribution, then the target model 330 accepts the first look ahead token and moves on to check the second look ahead token of the look ahead token sequence in a similar manner and so on. If the draft model probability distribution is greater than target model probability distribution, then the target model 330 rejects the first token (or whichever token is being checked) and stops checking the remaining look ahead tokens in the sequence. The target model 330 checks the look ahead tokens in parallel while generating a token of its own in a single pass. As such, even if only one look ahead token from the draft model (i.e., the first token, “The”) is accepted by the target model 330, the speculative decoding configuration 300 potentially provides at least some level of decreased latency compared to utilizing the target model 330 by itself.

In some cases, the acceleration provided by the speculative decoding configuration 300 depends on the look ahead window size 320 (i.e., the number of look ahead tokens generated by the draft model 310). For example, if the look ahead window size 320 is too small, the target model 330 will routinely accept all of the look ahead tokens generated by the draft model 310. This means that the target model 330 has the opportunity to accept more tokens, which indicates that greater acceleration is possible by increasing the look ahead window size 320 (i.e., increasing the number of look ahead tokens generated by the draft model 310 and transmitted to the target model 330). On the other hand, if the look ahead window size 320 is too large, the target model 330 will routinely reject many of the look ahead tokens generated by the draft model 310, resulting in diminishing improvements in latency since more time is wasted on multiple passes through the draft model 310 to generate look ahead tokens that end up being rejected by the target model 330. To resolve these potential problems, the techniques disclosed herein employ a statistical approach to determine a look ahead window size 320 that maximizes the speculative decoding speed up or acceleration, thereby improving LLM inferencing efficiency.

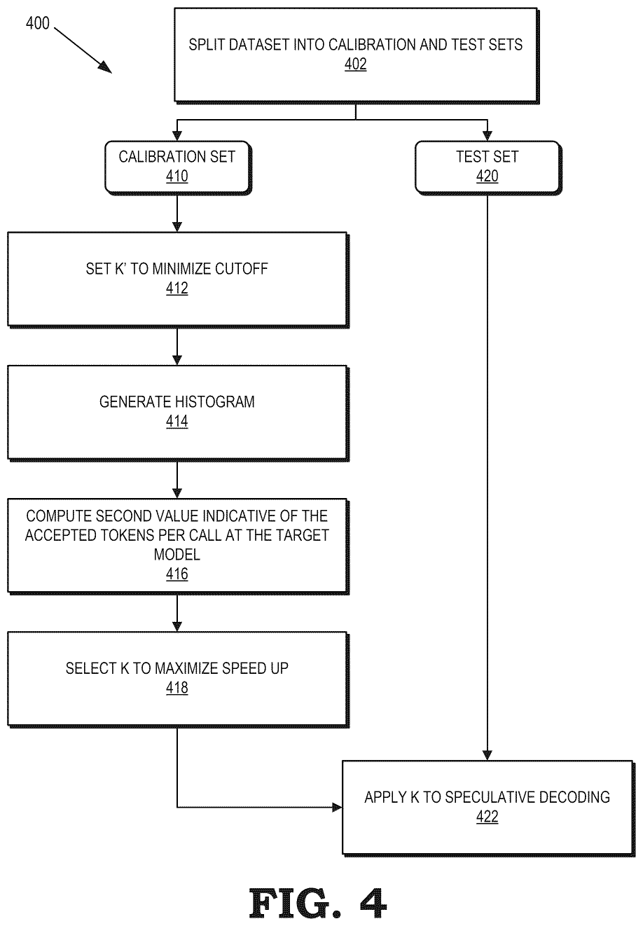

FIG. 4 shows an example of a flowchart 400 illustrating a method for an APU, such as the APU 105 of FIGS. 1 and 2, to perform speculative decoding by employing a statistical approach to determine a look ahead window size in accordance with some embodiments.

At block 402, the APU 105 splits an input dataset (e.g., such as a dataset retrieved from a memory such as the memory 115 of FIG. 1) into a first set 410 (referred to herein as a “calibration set”) and a second set 420 (referred to herein as a “test set” or “validation set”). For example, in some embodiments, the calibration set 410 is a smaller, distinct subset of the input dataset relative to the test set 420.

At block 412, the APU 105 selects a first value, denoted as K′, indicative of a quantity of look ahead tokens generated by the draft model per call to the target model (i.e., the first value is an initial calibration set look ahead window size). The first value K′ is set at a high number (e.g., 50 or more) to minimize or eliminate the potential for a cut-off in a histogram generated on the calibration set at the subsequent block 414.

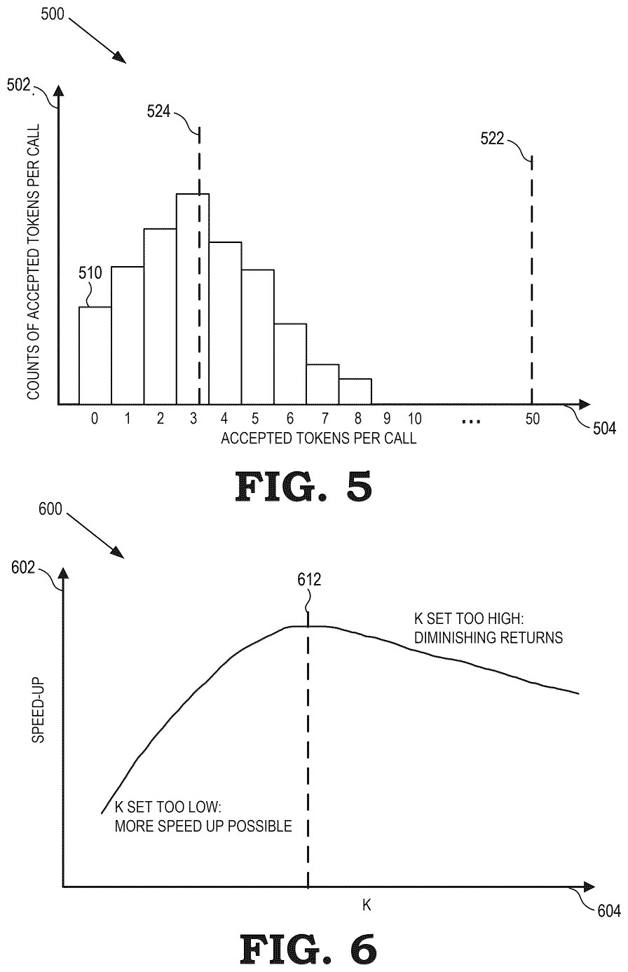

At block 414, the APU 105 utilizes the calibration set 410 to generate a histogram or other historical data distribution. An example histogram 500 is illustrated in FIG. 5. In the histogram 500, the x-axis 504 represents the accepted look ahead tokens generated by a draft model per call (i.e., per pass) to the target model, and the y-axis 502 represents the counts of the accepted look ahead tokens generated by a draft model per call to the target model. Thus, each bar 510 (only the first bar at “0” counts is labeled for clarity purposes) represents the number of counts (i.e., occurrences) that the indicated number of look ahead tokens were accepted by the target model for the speculative decoding run on the calibration set with a look ahead window size of K′, where K′ is indicative of a quantity of look ahead tokens generated by the draft model per call to the target model that is selected at block 412. In the illustrated embodiment, K′ is shown by the dashed line 522. As illustrated in the histogram, the APU selects the value for K′ to be high (e.g., 50 in this example) relative to the data collected in the histogram 500 to minimize or eliminate the possibility of cutting off (or clipping) the data of the histogram. That is, the APU sets the initial value for K′ illustrated by the dashed line 522 to minimize clipping of the data distribution in the histogram 500. For example, in the illustrated embodiment, if K′ had instead been selected to be 7, the data for accepted tokens for 8 and 9 along the x-axis 504 of the histogram 500 would have been treated as if they were instead at 7. In other words, setting K′ too low may clip the tail of the histogram 700, which will result in stacking the data that is clipped to the last bar in the histogram 700 (e.g., if the data for 8 is clipped, the corresponding data would be stacked on top of the data at 7, potentially forming a spike at the right side of the histogram 500).

Referring back to FIG. 4, at block 416, the APU 105 computes a second value indicative of the number of look ahead tokens that are expected to be accepted per call at the target model. For example, in some embodiments, the second value is the average number of tokens of the histogram 500 of FIG. 5 and is represented by the dashed line 524 at about 3.8 along the x-axis 504. In other embodiments, the second value is a certain percentile or percentage (e.g., top 70% percentile, top 80% percentile, etc.) of the number of look ahead tokens that are accepted by the target model.

At block 418, the APU 105 selects a look ahead window size, K, to maximize the speculative decoding (SD) speed up. In some embodiments, this includes the APU 105 selecting the look ahead window size to maximize the expected parameters read reduction (EPRR):

$$E P R R = \frac{parameters read without S D}{parameters read with S D} = \frac{( {E}_{K} [ n ] + 1 ) {parameters}_{target}}{K * {parmeters}_{draft} + {paremeters}_{target}}$$

where E_{K}[n] is the second value computed at block 416 (e.g., the average value represented by the dashed line 524 in FIG. 5), parameters_{target} is the number of parameters in the target model, and parameters_{draft} is the number of parameters in the draft model.

By selecting the look ahead window size to maximize the EPRR, the APU 105 is in effect selecting the look ahead window size to maximize the speed up of speculative decoding since decreasing the number of parameters read during speculative decoding from the draft model and the target model increases the speculative decoding speed (i.e., reading fewer parameters=less time). In some embodiments, the APU 105 employs the following equation to select the look ahead window size, K, to maximize the speed up, which considers the time to read parameters to be proportional to the number of parameters—with or without speculative decoding:

$$speed - up = \frac{( {E}_{K} [ n ] + 1 ) {t}_{target}}{K * {t}_{draft} + {t}_{target}}$$

where t_{target} is the time for a run on the target model (i.e., time per pass on the target model) and t_{draft} is the time for a run on the draft model (i.e., time per pass on the draft model, which is generally less than t_{target} since the draft model has fewer parameters). The above speed-up equation, in some embodiments, provides a ratio that is time-to-time and assumes that the time to read parameters is proportional to the number of parameters. In other words, in some embodiments, the speed-up equation above assumes a constant read bandwidth (i.e., number of parameters read per unit of time). In some embodiments, the speed-up for speculative decoding (SD) can account for different bandwidths and can be represented by the following equation:

$$speed - {up}_{BW} = \frac{( {E}_{K} [ n ] + 1 ) \frac{{parameters}_{target}}{{bandwidth}_{target\_WO \_SD}}}{K * \frac{{parameters}_{draft}}{{bandwidth}_{draft\_SD}} + \frac{{parameters}_{target}}{{bandwidth}_{target\_SD}}}$$

where bandwidth_{target_WO_SD} is the delivered bandwidth to the target model without speculative decoding, bandwidth_{draft_SD} is the delivered bandwidth to the draft model with speculative decoding, and bandwidth_{target_SD} is the delivered bandwidth to the target model with speculative decoding. The above speed-up_{BW} equation accounts for different bandwidths in non-speculative decoding (i.e., without speculative decoding) versus speculative decoding. For example, in some cases, during speculative decoding, the delivered bandwidth (parameters read per unit time) is lower than in non-speculative decoding cases. However, despite the lower delivered bandwidth, speculative decoding can still provide a speed-up because the draft model is small enough (relative to the target model) and the techniques disclosed herein select a window size (K) to maximize the speed-up or acceleration of speculative decoding.

In some embodiments, the APU 105 plots the speed-up (or acceleration) as a function of K and selects the look ahead window size based on the maximum value of the speed-up and the corresponding value for K. FIG. 6 shows an example graph 600 plotting the speed-up on the y-axis 602 as a function of K on the x-axis 604. As illustrated, the speed-up has a maximum value at value of K corresponding to the dashed line 612, which is the value selected for K for the look ahead window size. In some embodiments, if the value of K is a non-integer (e.g., 3.4), the look ahead window size is rounded up to the next highest integer value (e.g., 3.4 is rounded up to 4) to use as the look ahead window size since the impact of rounding up is not as severe as the impact of rounding down (e.g., overestimating the value of K at dashed line 612 produces a higher speed-up than underestimating the value of K at the dashed line 612).

Referring back to FIG. 4, after the APU selects the look ahead window size, K, at block 418 (e.g., by plotting the speed-up as a function of K as illustrated in the graph 600 of FIG. 6), the APU at block 422 applies the selected look ahead window size, K, to speculative decoding based on the test set 420. For example, in some embodiments, the APU uses the look ahead window size, K, in multiple speculative decoding iterations in speculative decoding configuration with a draft model and a target model as illustrated in FIG. 3.

In some embodiments, the speed-up is similar for the calibration set (such as the calibration set 410 of FIG. 4) and the test set (such as the test set 420 of FIG. 4). If not, the techniques described herein are repeated for another calibration set such that it accurately represents the input distribution that the LLM sees during deployment.

In some embodiments, the apparatus and techniques described above are implemented in a system including one or more integrated circuit (IC) devices (also referred to as integrated circuit packages or microchips), such as the APU described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
splitting an input dataset into a first set and a second set for speculative decoding using a draft model that generates look ahead tokens for a target model;
with the first set:
computing an expected number of look ahead tokens accepted by the target model per call based on a first value indicative of a quantity of look ahead tokens generated by the draft model; and
modifying the quantity of look ahead tokens generated by the draft model to a second value based on the expected number of look ahead tokens accepted by the target model; and
with the second set, performing speculative decoding with a look ahead window size based on the second value.

2. The method of claim 1, further comprising:
selecting the first value based on a historical data distribution of accepted tokens per call to the target model.

3. The method of claim 2, wherein the first value is selected to minimize clipping of the historical data distribution.

4. The method of claim 2, wherein computing the expected number of look ahead tokens accepted by the target model per call based on the first value comprises:
computing an average number of look ahead tokens that are accepted by the target model based on the historical data distribution of accepted tokens per call to the target model.

5. The method of claim 2, wherein computing the expected number of look ahead tokens accepted by the target model per call based on the first value comprises:
computing a percentage of look ahead tokens that are accepted by the target model based on the historical data distribution of accepted tokens per call to the target model.

6. The method of claim 2, wherein modifying the quantity of look ahead tokens generated by the draft model to the second value based on the expected number of look ahead token accepted by the target model comprises:
computing an expected parameters read reduction value based on a ratio of parameters read without speculative decoding to parameters read with speculative decoding.

7. The method of claim 6, wherein the parameters read without speculative decoding is represented by a product of a first target parameter value and the expected number of look ahead tokens accepted by the target model plus one.

8. The method of claim 7, wherein the first target parameter value is a ratio of a number of parameters in the target model to a delivered bandwidth to the target model without speculative decoding.

9. The method of claim 6, wherein the parameters read with speculative decoding is represented by adding a second target parameter value to a product of the second value and a draft parameter value.

10. The method of claim 9, wherein the second target parameter value is a ratio of a number of parameters in the target model to a delivered bandwidth to the target model with speculative decoding, and wherein the draft parameter value is a ratio of a number of parameters in the draft model to a delivered bandwidth to the draft model with speculative decoding.

11. The method of claim 1, wherein performing the speculative decoding with the look ahead window size based on the second value comprises multiple speculative decoding iterations.

12. A processing unit configured to:
split an input dataset for speculative decoding using a draft model that generates look ahead tokens for a target model into a first set and a second set;
with the first set:
compute an expected number of look ahead tokens accepted by the target model per call based on a first value indicative of a quantity of look ahead tokens generated by the draft model per call to the target model; and
modify the quantity of look ahead tokens generated by the draft model to a second value based on the expected number of look ahead tokens accepted by the target model; and
perform speculative decoding using the second set, wherein the speculative decoding employs a look ahead window size based on the second value.

13. The processing unit of claim 12, wherein the processing unit is configured to select the first value based on a historical data distribution of accepted tokens per call to the target model.

14. The processing unit of claim 13, wherein the first value is selected to minimize clipping of the historical data distribution.

15. The processing unit of claim 13, wherein computing the expected number of look ahead tokens accepted by the target model per call based on the first value comprises:
computing a percentage of look ahead tokens that are accepted by the target model based on the historical data distribution of accepted tokens per call to the target model.

16. The processing unit of claim 13, wherein modifying the quantity of look ahead tokens generated by the draft model to the second value based on the expected number of look ahead token accepted by the target model comprises:
computing an expected parameters read reduction value based on a ratio of parameters read without speculative decoding to parameters read with speculative decoding.

17. The processing unit of claim 16, wherein the parameters read without speculative decoding is represented by a product of a first target parameter value and the expected number of look ahead tokens accepted by the target model plus one.

18. The processing unit of claim 17, wherein the first target parameter value is a ratio of a number of parameters in the target model to a delivered bandwidth to the target model without speculative decoding.

19. The processing unit of claim 16, wherein the parameters read with speculative decoding is represented by adding a second target parameter value to a product of the second value and a draft parameter value, wherein the second target parameter value is a ratio of a number of parameters in the target model to a delivered bandwidth to the target model with speculative decoding, and wherein the draft parameter value is a ratio of a number of parameters in the draft model to a delivered bandwidth to the draft model with speculative decoding.

20. A system comprising:
a memory configured to store a plurality of datasets to serve as inputs for speculative decoding using a draft model that generates look ahead tokens for a target model;
a processing unit configured to:
retrieve, from the memory, a dataset of the plurality of datasets and split the dataset into a first set and a second set;
using the first set:
compute an expected number of look ahead tokens accepted by the target model per call based on a first value indicative of a quantity of look ahead tokens generated by the draft model per call to the target model; and
modify the quantity of look ahead tokens generated by the draft model to a second value based on the expected number of look ahead tokens accepted by the target model; and
perform speculative decoding using the second set, wherein the speculative decoding employs a look ahead window size based on the second value.
